(19) United States
(12) Patent Application Publication
(10) Pub. No.: US 2026/0194544 A1
(43) Pub. Date: Jul. 9, 2026

(54) DEVICES AND METHODS FOR TRANSPORTING SAMPLE CONTAINERS IN DIAGNOSTIC LABORATORY SYSTEMS

(71) Applicant: Siemens Healthcare Diagnostics Inc., Tarrytown, NY (US)

(72) Inventors: Klaus Kirchberg, Plainsboro, NJ (US); Mark Edwards, Armonk, NY (US); Rayal Prasad, Princeton, NJ (US); Ankur Kapoor, Plainsboro, NJ (US)

(73) Assignee: Siemens Healthcare Diagnostics Inc., Tarrytown, NY (US)

(21) Appl. No.: 19/128,213

(22) PCT Filed: Nov. 16, 2023
(86) PCT No.: PCT/US2023/080006

§ 371 Date: May 8, 2025

Related U.S. Application Data
(60) Provisional application No. 63/384,061, filed on Nov. 16, 2022.

(51) Int. Cl. G01N 35/00; G01N 35/04

(52) U.S. Cl. CPC G01N 35/0092; G01N 35/04; G01N 2035/0406; G01N 2035/046

(57) ABSTRACT

A method of operating a diagnostic laboratory system for analyzing a biological sample is provided. The method includes providing a track in the diagnostic laboratory system, wherein the track extends between a plurality of instruments; providing a plurality of sample carriers movable on the track; and modeling in software the track as a plurality of blocks, wherein each block limits the number of sample carriers therein and includes a movement pattern that indicates permitted directions in which sample carriers may move into and out of the block. The method includes communicating a vacancy of a first block and then moving a sample carrier to the first block from a second adjacent block in response to the communicated vacancy. Other methods and systems are disclosed.

### CROSS REFERENCE TO RELATED APPLICATION

This application claims the benefit of U.S. Provisional Patent Application No. 63/384,061, entitled “DEVICES AND METHODS FOR TRANSPORTING SAMPLE CONTAINERS IN DIAGNOSTIC LABORATORY SYSTEMS” filed Nov. 16, 2022, the disclosure of which is hereby incorporated by reference in its entirety for all purposes.

### FIELD

This disclosure relates to devices and methods for transporting sample containers in diagnostic laboratory systems.

### BACKGROUND

Diagnostic laboratory systems may conduct clinical chemistry or assays to identify analytes or other constituents in biological samples such as blood serum, blood plasma, urine, interstitial liquid, cerebrospinal liquids, and the like. The samples may be received in and/or transported throughout laboratory systems in sample containers. Many diagnostic laboratory systems process large volumes of sample containers and the samples contained therein.

The processing of samples includes transporting sample containers on tracks throughout the diagnostic laboratory systems. As the diagnostic laboratory systems increase in size, the complexities of the respective tracks increase. The complexities of transport programs that generate instructions to transport sample containers also increase, which may slow sample transportation or cause issues such as sample container collisions. Accordingly, systems and methods that provide simplified sample container transportation throughout diagnostic laboratory systems are sought.

### SUMMARY

According to a first aspect, a method of operating a diagnostic laboratory system for analyzing a biological sample is provided. The method includes providing a track in the diagnostic laboratory system, wherein the track extends between a plurality of instruments; providing a plurality of sample carriers movable on the track; modeling in software via a computer the track as a plurality of blocks, wherein each block includes a movement pattern that indicates permitted directions in which sample carriers move into or out of the block; sensing via a track sensor a vacancy of the first block; and moving a sample carrier into the first block from a second block adjacent the first block in response to the sensing the vacancy of the first block.

In another aspect, a diagnostic laboratory system for analyzing a biological sample is provided. The system includes at least one instrument for preparing or testing the biological sample; a track configured to transport a sample container to and from the at least one instrument, wherein the sample container is configured to contain therein the biological sample to be analyzed; and a computer configured to: model in software the track as a plurality of blocks, wherein each block includes a movement pattern that indicates one or more permitted directions in which the sample carrier moves into or out of the block; identify at least one test to be performed on the biological sample by the at least one instrument; and determine a path along the track to the at least one instrument, wherein the path includes at least a first block and a second block adjacent the first block. The system further includes a first segment controller associated with the first block; and a second segment controller associated with the second block and in communication with the first segment controller; wherein the first segment controller is operative to communicate that the first block is vacant; and wherein the second segment controller is operative to facilitate movement of the sample container from the second block to the first block in response to receiving communication from the first segment controller that the first block is vacant.

In a further aspect, a method of moving a sample carrier in a diagnostic laboratory system for analyzing a biological sample is provided. The method includes providing a track in the diagnostic laboratory system, wherein the track extends between a plurality of instruments; providing a sample carrier containing a biological sample, the sample carrier being movable on the track; modeling in software via a computer the track as a plurality of blocks, wherein each block includes a movement pattern that indicates one or more permitted directions in which the sample carrier moves into or out of that block, and wherein each block is configured to have therein only one sample carrier at a time; providing a plurality of segment controllers configured to control transport of the sample carrier through the plurality of blocks, wherein the movement pattern of each block is defined by a segment controller associated with that block; identifying at least one test to be performed on the biological sample using at least one instrument; employing a routing program to generate a routing plan for the sample carrier, wherein the routing plan includes a list of blocks through which the sample carrier will travel to reach the at least one instrument; generating a queue of block commands for each block in the list of blocks; and moving the sample carrier through the blocks in the list of blocks based on the queue of block commands for each block in the list of blocks.

Still other aspects, features, and advantages of this disclosure may be readily apparent from the following description and illustration of a number of example embodiments, including the best mode contemplated for carrying out the disclosure. This disclosure may also be capable of other and different embodiments, and its several details may be modified in various respects, all without departing from the scope of the disclosure.

### BRIEF DESCRIPTION OF THE DRAWINGS

The drawings, described below, are provided for illustrative purposes and are not necessarily drawn to scale. Accordingly, the drawings and descriptions are to be regarded as illustrative in nature, and not as restrictive. The drawings are not intended to limit the scope of the disclosure in any way.

FIG. 1A illustrates a diagram of a diagnostic laboratory system according to one or more embodiments.

FIG. 1B illustrates an enlarged portion of a track of the diagnostic laboratory system of FIG. 1A according to one or more embodiments.

FIG. 1C illustrates an enlarged portion of the track of FIG. 1B showing individual blocks and transportation components according to one or more embodiments.

FIG. 1D illustrates an isometric enlarged view of a portion of the track of FIG. 1A including two sample carriers holding sample containers, wherein the sample containers contain samples, and wherein the sample carriers are independently movable according to one or more embodiments.

FIG. 1E illustrates a side elevation view of one of the sample carriers and sample containers of FIG. 1D according to one or more embodiments.

FIG. 1F illustrates an isometric enlarged view of a portion of the track of FIG. 1A including two sample carriers holding sample containers, wherein the sample containers contain samples, and wherein the sample carriers are independently movable by way of linear motors according to one or more embodiments.

FIG. 1G illustrates a side elevation view of one of the sample carriers and sample containers of FIG. 1F according to one or more embodiments.

FIG. 2 illustrates a block diagram of an embodiment of the track of the diagnostic laboratory system of FIG. 1A modeled in software as a plurality of adjacent blocks according to one or more embodiments.

FIGS. 3A-3D illustrate enlarged views of certain ones of the blocks of the diagnostic laboratory system of FIG. 1A and the block diagram of FIG. 2 according to one or more embodiments.

FIG. 4 illustrates a portion of the track of FIG. 1A showing movements of a first sample carrier and a second sample carrier according to one or more embodiments.

FIGS. 5A-5H illustrate the portion of the track shown in FIG. 4 at various time steps according to one or more embodiments.

FIG. 6 illustrates an example of two blocks each having a respective queue of block commands for the example described in FIGS. 5A-5H according to one or more embodiments.

FIG. 7 illustrates instructions to implement the block command for transitions related to time T=2 in FIG. 6 where a sample carrier is moved between blocks according to one or more embodiments.

FIG. 8 illustrates a block diagram of another embodiment of the track of the diagnostic laboratory system of FIG. 1A modeled in software as a plurality of adjacent blocks, wherein some of the blocks have different movement patterns than in the track embodiment of FIG. 2 according to one or more embodiments.

FIG. 9 illustrates three-dimensional blocks representing a portion of a multi-level track in a diagnostic laboratory system that may move sample carriers and/or sample containers in three dimensions according to one or more embodiments.

FIG. 10 illustrates a flowchart of a method for operating a diagnostic laboratory system for analyzing a biological sample according to one or more embodiments.

FIG. 11 illustrates a flowchart of a method for moving a sample carrier in a diagnostic laboratory system for analyzing biological samples according to one or more embodiments.

### DETAILED DESCRIPTION

An automated diagnostic laboratory system may transport sample containers to different instruments via a track. A routing program may determine routes on the track that each of the sample containers takes to reach the instruments that perform specific tests on samples stored in the sample containers. Routing becomes more complex as more sample types and testing capabilities are added to diagnostic laboratory systems. For example, sample containers may have to pass one another and/or yield to one another at certain times to arrive at specific instruments at specific times. The routing becomes even more complex when high priority samples are added because the routing must be updated so that low priority samples yield to the high priority samples.

Diagnostic laboratory systems may be arranged in different physical configurations (e.g., layouts of the track and instruments). Routing programs generally must be customized to the specific diagnostic laboratory configurations employed. However, customizing routing programs for each different configuration is difficult and increases the costs of implementing diagnostic laboratory systems.

Embodiments of diagnostic laboratory systems and routing methods described herein use dynamic routing algorithms to transport sample containers on one or more tracks throughout the laboratory systems. Each track may be modeled in software via a computer as small segments or blocks, wherein each block represents a portion of the track configured to have therein only one sample carrier at a time. Movement and tracking of the sample carriers are based on movement of sample carriers from one block to an adjacent block rather than over the entire track. Each block may be controlled by a segment controller that determines and/or controls, for example, whether and/or how sample carriers move to and/or from each block. A segment controller may control one or more blocks (e.g., 1, 2, 3, 4, 5, or more blocks).

Each block may have a movement pattern (e.g., up, down, left, right as illustrated in a plan view) associated therein that indicates in which direction(s) sample carriers are permitted to move into and/or out of that block. For example, certain blocks may only receive sample carriers from the left and pass them one at a time to the right to an adjacent block (e.g., a target block). Intersection blocks may, for example, receive sample carriers from the left and pass them either to the right or down (as illustrated in a plan view) to adjacent target blocks. Movement from one block to an adjacent target block is only permitted if the target block is not occupied. Otherwise, the sample carrier waits for that target block to be vacant, meaning that the target block has no sample carrier therein.

Alternatively, instead of block modeling, the track layout may be represented as a graph of nodes and edges, wherein the nodes may be analogous to the blocks and the movement patterns may define the edges connecting the nodes. A graph representation of a track layout is more general than a block model (using a Cartesian grid) of the track layout. For example, such a graph can represent a track layout with non-uniform block sizes. This duality of representations (Cartesian grid vs. graph) allows a flexible choice of software programming within the routing program for routing of sample carriers throughout a diagnostic laboratory system.

In some embodiments, a block may be as small as possible to allow maximum traffic in the system, but large enough so that each block may still have therein at least one sample carrier within its boundary. The block size, including motion patterns (e.g., up, down, left, right) of each block, may be determined from the physical layout of the track, the placement and capabilities of associated segment controllers and track sensors, dimensions of sample carriers, and/or the like. A routing program executed by a system controller or like computer, e.g., may then configure sample carrier routing based on the software model of the blocks representing the track, wherein routing is based on motion of the sample carriers from one block to an adjacent block.

In some embodiments, the routing program may include inputs of the current positions of all sample carriers as well as a corresponding list of sample carrier destinations. The routing program then may generate a routing plan which may include a respective list of blocks through which each of the sample carriers will travel to reach its destination. In some embodiments, the routing program may generate a corresponding list of discrete sequential steps (i.e., a queue of block commands) for each sample carrier and may transmit the sequential steps to one or more segment controllers for execution, wherein each segment controller controls movement of sample carriers through one or more respective blocks. In other embodiments, the segment controllers may receive the routing plan and generate a corresponding list of discrete sequential steps (queue of block commands) for the respective blocks under their control. Example sample carrier steps may include moving to an adjacent target block at step S1 or staying in place (e.g., while another sample carrier moves first through an adjacent intersection block or until an adjacent block has a sample carrier vacancy) at step S2. As mentioned above, blocks are configured to be occupied by only one sample carrier at a time. Thus, if a target block is occupied, a sample carrier cannot move to the target block until the target block is vacant. Note that for each sample carrier step, the positions of all sample carriers are known to avoid collisions.

In some embodiments, each block command may include the time (e.g., time of day or relative time step, e.g., T1, T2, etc.) at which the block command is to be executed (e.g., when to begin the block command), an IN or OUT command (e.g., whether the sample carrier is entering a block or leaving the block), sample carrier identification (e.g., the identification of the sample carrier entering or leaving the block), and/or direction of movement (e.g., up, down, left, right, etc.) of the sample carrier into or out of the block.

In one or more embodiments, each block may have a series of block commands associated with it that depend on the order in which sample carriers arrive at the block. Thus, the actual indicated time at which block commands should be executed may be ignored. For example, if a sample carrier is to wait at a block (e.g., for a predetermined time period, until a predetermined time, until an adjacent target block is empty, until a sample container is ready to be moved to the block from an adjacent block, until a segment controller controlling the block receives a signal from another segment controller, etc.) a WAIT command may be included as a block command but may need to be executed longer than originally planned. In other embodiments, the routing plan may be executed in less time than originally planned. The routing plan may thus become an event-driven plan wherein each block command of a block is performed in order. Thus, the original routing plan may still be executed correctly without exactly adhering to a time of day or relative time step included in the block command.

A block software model of a track provides for less complex routing computation. For example, by transforming a time-driven routing plan to an event-driven routing plan (e.g., waiting for vacant target blocks), the routing can be performed asynchronously, which relaxes the network latency requirement. In addition, once the routing plan (and block commands in some embodiments) are transmitted to the segment controllers, the only required communication is between segment controllers of adjacent blocks (e.g., to ensure sample carriers are moved into unoccupied, adjacent blocks). In some embodiments, the communication may be limited to signals indicating that blocks are vacant.

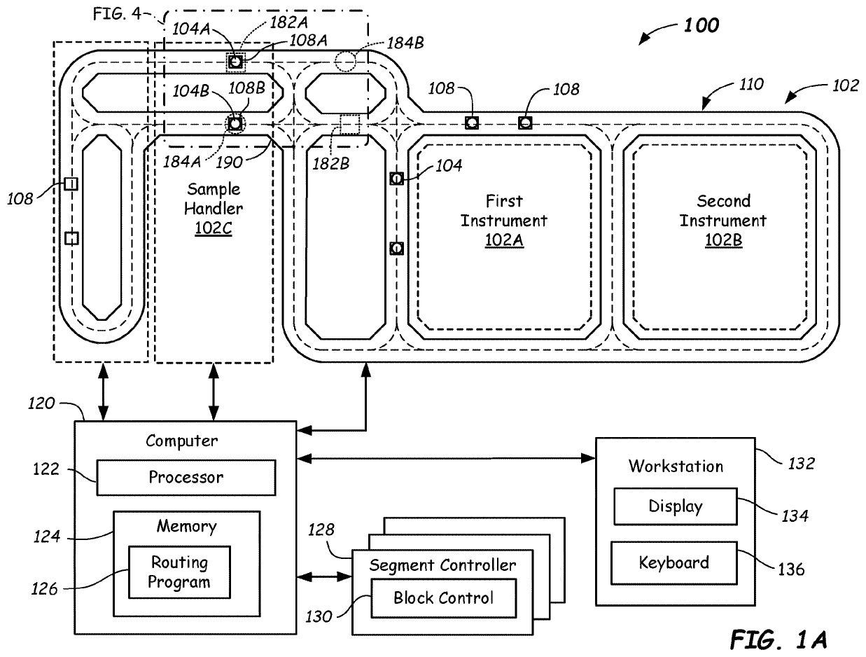

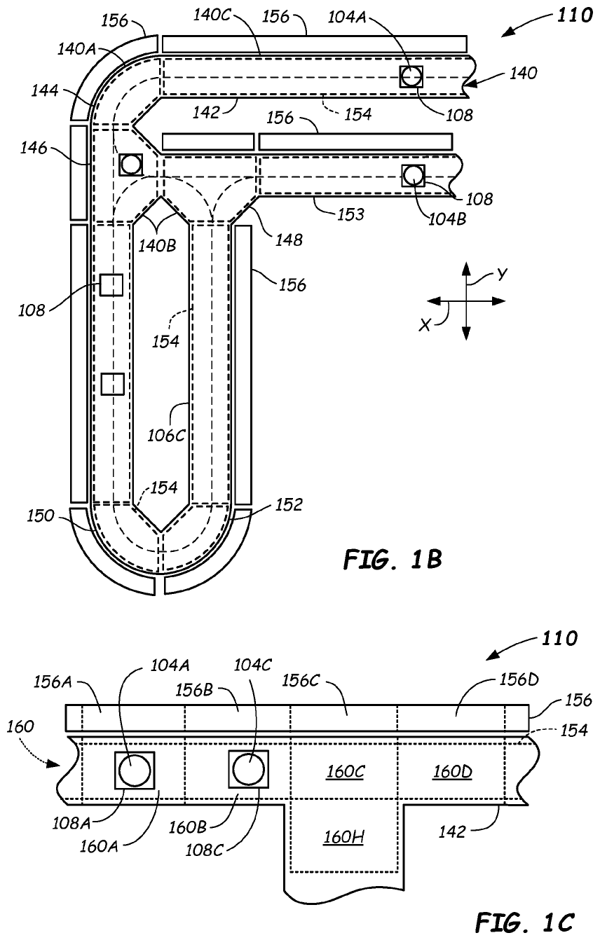

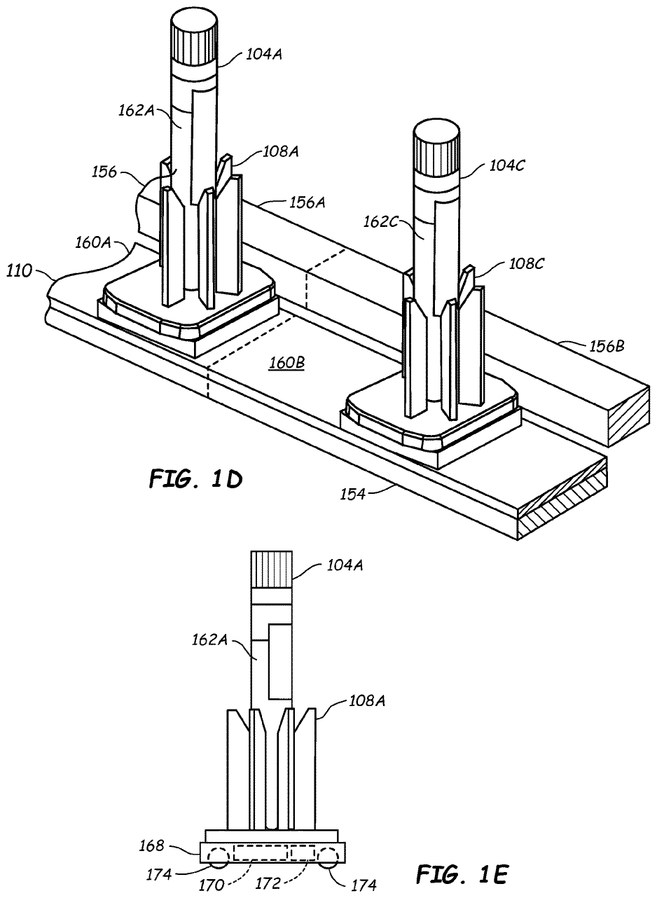

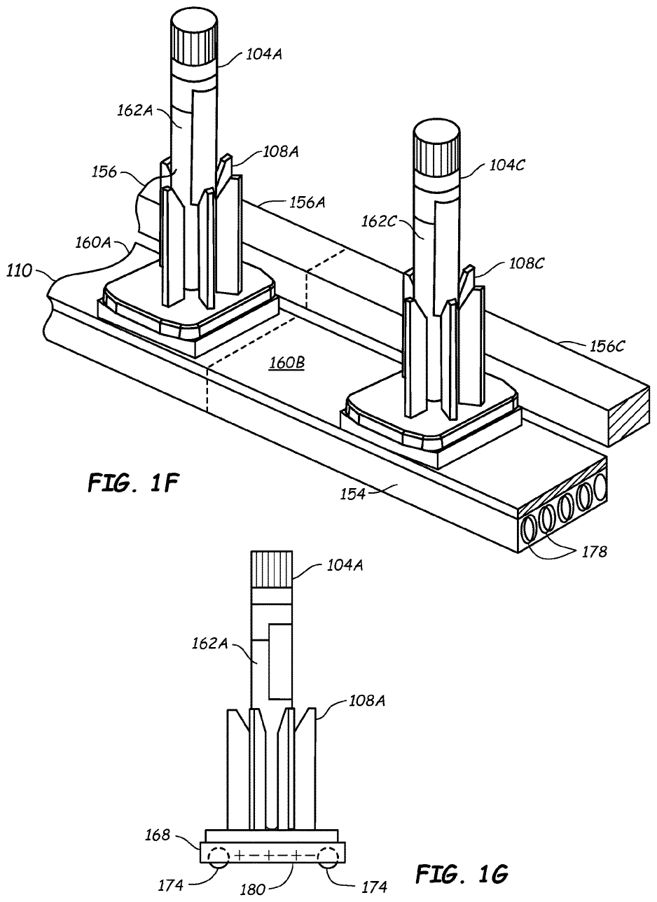

These and other systems and methods are described below in greater detail with reference to FIGS. 1A-11.

Reference is now made to FIG. 1A, which illustrates a diagram of an example embodiment of an automated diagnostic laboratory system 100 according to one or more embodiments. The laboratory system 100 may include a plurality of instruments 102 configured to process sample containers 104 (a few labelled) and to conduct assays or tests on biological samples contained in the sample containers 104. The laboratory system 100 may have a first instrument 102A and a second instrument 102B. In addition, the laboratory system 100 may include a third instrument configured as a sample handler 102C. The sample handler 102C is configured to receive the sample containers 104 into the laboratory system 100. The first instrument 102A and/or the second instrument 102B may perform analyses on the samples (e.g., sample 162A-FIG. 1D) located in the sample containers 104. Other embodiments of the laboratory system 100 may include more or fewer instruments.

The samples located in the sample containers 104 may be various biological specimens collected from individuals, such as patients being evaluated by medical professionals. The samples may be collected from the patients and placed into the sample containers 104. The sample containers 104 may then be delivered to the laboratory system 100. The sample containers 104 may be loaded into the sample handler 102C. From the sample handler 102C, the sample containers 104 may be transferred into sample carriers 108 (a few labelled) that transport the sample containers 104 throughout the laboratory system 100, such as to the instruments 102, by way of a track 110. Once a sample container is introduced into the laboratory system 100 and placed on a sample carrier, the sample carrier is then instructed to visit a certain set of destinations (i.e., instruments 102 and/or other components or locations). The set of destinations may be in a particular sequence. For example, the sample container may need to visit a centrifuge first followed by a decapper. In some situations, the sample container may have to visit the destinations within a specific time window. For example, after decapping, the specimen container may have to be aspirated within a specific period of time. The laboratory system 100 includes a first sample container 104A located in a first sample carrier 108A and a second sample container 104B located in a second sample carrier 108B that are described in greater herein.

The track 110 is configured to enable the sample carriers 108 to move throughout the laboratory system 100 including to and from the sample handler 102C in response to transport instructions described herein. For example, the track 110 may extend proximate and/or around at least some of the instruments 102 as shown in FIG. 1A. The instruments 102 may have devices, such as robots (not shown in FIG. 1A), that transfer the sample containers 104 to and from the sample carriers 108. The track 110 may have electronic transport components (not shown in FIG. 1A) that move the sample containers 104 via the sample carriers 108 and/or monitor the locations of the sample containers 104 on the track 110.

The instruments 102 and the transport components may include or be coupled to a computer 120 (e.g., a central system controller) configured to execute one or more programs that control operation of the laboratory system 100. The computer 120 may be configured to communicate with the instruments 102, the transport components, and other components of the laboratory system 100. The computer 120 may include a processor 122 configured to execute programs including programs other than those described herein. The programs may be implemented in computer code. In some embodiments, the computer 120 may be remote from the instruments 102. Additionally, in some embodiments, the computer 120 may control the operation of a plurality of different laboratory systems. Thus, data generated by the laboratory system 100 may be stored and/or processed remote from the laboratory system 100. The computer 120 may include or have access to memory 124 that may store one or more programs and/or data described herein. The memory 124 and/or programs stored therein may be referred to as non-transitory computer-readable mediums. In some embodiments, the memory may be remote from the other components of the computer 120.

The memory 124 may include a routing program 126 (e.g., computer code executable by the processor 122) configured to generate routes (e.g., routing plans) for the sample carriers 108 (carrying sample containers 104). The routes may direct the sample carriers 108 to specific ones of the instruments 102 to perform tests on samples in the sample containers 104.

The automated diagnostic laboratory system 100 may also include one or more segment controllers 128. Each segment controller 128 may control movement of sample carriers 108 through one or more designated blocks of the track 110. Each segment controller 128 may include a processor, a transceiver or the like, and a memory storing a block control program 130 (e.g., computer code executable by the processor). The block control program 130 is configured to generate instructions that cause the sample carriers 108 to move to and through the one or more designated blocks. Thus, each block control program 130 may generate instructions that activate certain transport components on the track 110 to move certain sample carriers 108 to and/or through the one or more designated blocks controlled by the segment controller 128 executing that block control program 130. Each segment controller 128 may be positioned around the track 110 at or near the block(s) it controls. Each segment controller 128 may communicate with computer 120 and/or each other via an Ethernet or other suitable network using a wired and/or wireless connection. Each segment controller 128 may include components other than those described above. In alternative embodiments, the functions performed by the segment controllers 128 may be performed by separate (parallel) processors of computer 120 or another central computer, and the respective block control program 130 of each segment controller 128 may be stored in the memory 124 or the memory of the other central computer.

In some embodiments, the routing program 126 may generate paths and/or instructions for routing individual sample carriers 108 to and through blocks 160. For example, routing program 126 may identify which blocks a sample carrier 108 must travel through to reach an instrument. In some embodiments, the routing program 126 may also determine appropriate block commands for each block to execute (e.g., a queue of block commands) while in other embodiments, individual segment controllers 128 may determine the queue of block commands to perform based on block route information (e.g., the list of blocks for a sample carrier comprises a determined route to its designation) provided by routing program 126.

A workstation 132 may be electrically coupled to and in communication with the computer 120. In some embodiments, the workstation 132 may be remote from the track 110. The workstation 132 may include at least a display 134 and a keyboard 136. The workstation 132 enables users of the laboratory system 100 to input data to the computer 120 and enables the computer 120 to output data to the users, such as by the display 134.

The track 110 as illustrated includes dashed lines to show routes or paths that the sample carriers 108 (and thus the sample containers 104) may take within the laboratory system 100. As shown in FIG. 1A, the sample carriers 108 may take many routes throughout the laboratory system 100. The routing program 126 generates instructions that direct the sample carriers 108 to move on these routes to designated instruments or other destinations at scheduled times to keep the laboratory system 100 operating efficiently. In some embodiments, the routing program 126 may determine the most efficient paths for one or more of the sample carriers 108 given that there may be other sample carriers 108 travelling on the same path and/or to the same instruments or other destinations. The segment controllers 128 (each executing a respective block control program 130) may activate transport components (described below) on the track 110 for blocks under their control to move the sample carriers 108 on the paths determined by the routing program 126.

Additional reference is now made to FIG. 1B, which illustrates an enlarged portion of the track 110. The track 110 has different segments 140 that illustrate the sample carriers 108 moving in at least an x-direction and a y-direction and changing directions between the x-direction and the y-direction. The types of segments 140 include curved segments 140A that change the directions of the sample carriers 108 between x-directions and γ-directions and vice versa. Other types of segments 140 include intersection segments 140B that receive the sample carriers 108 from a first port and selectively output the sample carriers 108 to one of at least two other ports. The intersection segments 140B may also receive the sample carriers 108 from at least a first port and a second port and output the sample carriers 108 to a third port. The track 110 may also include straight segments 140C that continue motion of the sample carriers 108 in straight lines.

Specific segments of the track 110 are described in detail below with reference to operation of the routing program 126. A first segment 142 is a straight segment extending in the x-direction. A second segment 144 is a curved segment extending in the y-direction and the x-direction. A third segment 146 is an intersection segment extending in the y-direction with a branch extending in the positive x-direction. A fourth segment 148 is another intersection segment extending in the x-direction with a branch extending in the negative y-direction. A fifth segment 150 is a curve and a sixth segment 152 is a curve that is a mirror image of the fifth segment 150. A seventh segment 153 is parallel to the first segment 142.

The track 110 may include transport mechanisms 154 (a few labelled) configured to transport the sample carriers 108 on the track 110. Examples of the transport mechanisms 154 are illustrated in FIG. 1B as being positioned below the track 110. In other embodiments, the transport mechanisms 154 may be located beside the track 110, above the track 110, or in any other suitable location. Examples of the transport mechanisms 154 are described below with reference to FIGS. 1B-1G and may include movable belts and rollers (not separately shown), which use friction to move the sample carriers 108, and magnetic devices (see FIGS. 1F and 1G, for example), which magnetically move the sample carriers 108 relative to the track 110. In yet other examples, the sample carriers 108 may be self-propelled on the track 110 (e.g., see FIG. 1D, for example) and, in some embodiments, the sample carriers 108 may receive movement instructions wirelessly from the computer 120, the segment controllers 128, and/or the transport mechanisms 154. The transport mechanisms 154 are not limited to the examples described above. Any suitable mechanism that transports the sample carriers 108 via the track 110 through blocks may be employed as the transport mechanisms 154. The transport mechanisms 154 may receive signals from the segment controllers 128 (via execution of respective block control programs 130) that cause the transport mechanisms 154 to operate.

The laboratory system 100 may also include a plurality of track sensors 156 (a few labelled in FIG. 1B) configured to identify the positions of the sample containers 104 and/or the sample carriers 108 on the track 110. The track sensors 156 are illustrated as straight or curved rectangular shapes adjacent the segments 140 of the track 110. However, in some embodiments, a track sensor 156 may be an integral part of a track segment. Track sensors 156 may be any device that senses or determines the positions of the sample carriers 108 and/or the sample containers 104 and then transmits the position information to an associated segment controller 128 for processing by a block control program 130 and/or to the computer 120 for processing by the routing program 126. In some embodiments, the segment controllers 128 may forward position data received from the track sensors 156 to the computer 120. In some embodiments, the track sensors 156 may be small individual elements located adjacent the track 110. Examples of the track sensors 156 include optical devices that read indicia (not shown) located on the sample carriers 108 and/or the sample containers 104, radio frequency identification devices (RFIDs) that read RFID tags (not shown) located on the sample carriers 108 and/or the sample containers 104, etc. Other track sensors that determine positions of the sample containers 104 and/or the sample carriers 108 may be employed.

Additional reference is now made to FIG. 1C, which illustrates an enlarged portion of the first segment 142 transporting the first sample container 104A by way of the first sample carrier 108A and a third sample container 104C by way of a third sample carrier 108C. The track 110 is software modeled into a plurality of blocks 160. The portion of the first segment 142 shown in FIG. 1C is illustrated as having four blocks that are referred to individually as a first block 160A, a second block 160B, a third block 160C, and a fourth block 160D. Other numbers of blocks 160 may be modeled for a given portion of the track 110. As described in greater detail below, the transport mechanisms 154 are configured to move the first sample carrier 108A and/or the first sample container 104A and the third sample container 104C and/or the third sample carrier 108C to and through adjacent blocks 160.

The movement of the sample carriers 108 (and the sample containers 104) may be via linear motors, belts, signals and/or power applied to the sample carriers 108 when self-propelled sample carriers are employed, etc. For example, the transport mechanisms 154 may have hardware components associated with individual ones of the blocks 160 that are configured to move the sample carriers 108 to and through the individual ones of the blocks 160. In the embodiment of FIG. 1C, the transport mechanisms 154 are moving the first sample carrier 108A from the first block 160A to the second block 160B and the third sample carrier 108C from the second block 160B to the third block 160C. In some embodiments, each of the blocks 160 may include an individual transport mechanism. In other embodiments, a plurality of the blocks 160 may be associated with a single transport mechanism, wherein the single transport mechanism is configured to transport independently the first sample carrier 108A and the third sample carrier 108C between individual ones of the blocks 160.

In the embodiment of FIG. 1C, the track sensor 156 is illustrated as being portioned into a plurality of individual sensors. Each of the sensors may be configured to sense the position of the first sample carrier 108A in each of the blocks 160 and transmit the position information to one or more segment controllers 128 respectively associated with one or more blocks 160 and/or to computer 120 (for the routing program 126 and/or other components). A first sensor 156A is sensing the first sample carrier 108A in the first block 160A, a second sensor 156B is sensing the third sample carrier 108C in the second block 160B, a third sensor 156C senses sample carriers 108 (FIG. 1A) in the third block 160C, and a fourth sensor 156D senses sample carriers 108 in the fourth block 160D.

Additional reference is made to FIG. 1D, which is an isometric enlarged view of a portion of the track 110 of FIG. 1C. In the embodiment of FIG. 1D, the first sample container 104A is received in the first sample carrier 108A and contains a first sample 162A that may be analyzed by one or more of the instruments 102 (FIG. 1A). The embodiment of FIG. 1D also includes the third sample container 104C received in the third sample carrier 108C. A third sample 162C is located in the third sample container 104C. The transport mechanisms 154 of FIG. 1D may be a single mechanism that enables the first sample carrier 108A and the third sample carrier 108C to be moved independently into and out of the first block 160A and the second block 160B (e.g., such as by magnetic induction). For example, the transport mechanisms 154 may cause the first sample carrier 108A to wait within the first block 160A while moving the third sample carrier 108C from the second block 160B to the third block 160C. The track sensors 156 may be configured to identify the location of the first sample carrier 108A and the third sample carrier 108C on the track 110 and transmit position data to an associated segment controller 128 and/or the routing program 126 (FIG. 1A). In some embodiments, the blocks 160 may each be just slightly larger than a sample carrier 108. For example, the first block 160A may be slightly larger than the footprint of the first sample carrier 108A and the footprint of the third sample carrier 108C.

Additional reference is made to FIG. 1E, which illustrates an embodiment of the first sample carrier 108A configured to be self-propelled. The first sample carrier 108A may include a housing 168 in which a motor 170 and a receiver 172 may be located. The motor 170 may be coupled to wheels 174 extending from the housing 168. The receiver 172 may receive transport instructions from one of the segment controllers 128 indicating that the first sample carrier 108A is to move, such as from one block to an adjacent block. The receiver 172 may then activate the motor 170, which spins the wheels 174 and moves the first sample carrier 108A. In some embodiments, coils or the like may be in the transport mechanisms 154 and may generate electric fields that provide power to the motor 170. In other embodiments, appropriate electrical power may be provided to the motor 170 by other methods and devices to move the first sample carrier 108A.

Reference is made to FIGS. 1F and 1G, which illustrate an embodiment of the transport mechanisms 154 configured as linear motors. In the embodiment of FIG. 1F, the transport mechanisms 154 include coils 178 configured to generate magnetic fields in response to signals generated by the segment controllers 128 (FIG. 1A). The base 180 of the housing 168 (FIG. 1G) may be magnetized so that force may be applied to the base 180 as the magnetic fields generated by the coils 178 change. The force causes the first sample carrier 108A to move on the track 110.

The routing program 126 generates paths or routes to move the sample carriers 108 on the track 110 and, in some embodiments, queues of block commands to move the sample carriers accordingly. The queues of block commands may then be parsed based on the specific blocks in the generated paths or routes and transmitted to the one or more segment controllers 128 that control movement of sample carriers through those specific blocks. The associated block control programs 130 of those one or more segment controllers 128 may then generate electric signals that cause the transport mechanisms 154 along the track 110 to move the sample carriers 108 per the block commands. In embodiments where the sample carriers 108 are self-propelled, the segment controllers 128 may include one or more transceivers or radio transmitters that transmit instructions directly or indirectly to the sample carriers 108 upon the segment controllers receiving position data generated by the track sensors 156 as individual sample carriers 108 arrive at the specific blocks under the control of the segment controllers 128. The segment controllers 128 may forward the position data to the routing program 126 for updating paths and block commands for other sample carriers 108 as described herein.

The routing plan generated by the routing program 126 ultimately causes the transport mechanisms 154 to move each of the sample containers 104 (via the sample carriers 108) to a certain set of destinations, such as different ones of the instruments 102. These movements may cause each of the sample containers 104 to visit the destinations in a particular sequence, such as visiting a centrifuge followed by visiting a decapper. The routing plan may specify specific time windows which have to be adhered to for visiting certain destinations and performing certain time-sensitive tests. The laboratory system 100 may have hundreds or thousands of sample carriers 108 moving simultaneously to perform a plurality of different tests on the samples (e.g., first sample 162A-FIG. 1D) contained in the sample containers 104.

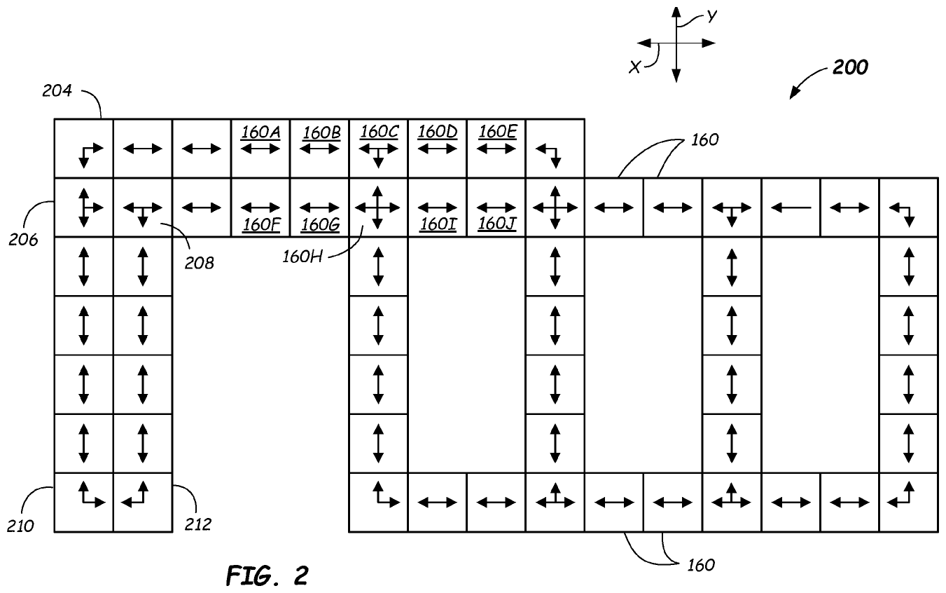

Additional reference is made to FIG. 2, which is an example of a block diagram 200 illustrating an embodiment of the track 110 modeled as a plurality of adjacent blocks 160 (a few labelled). Other modeled block representations are possible and may include many more blocks 160 or fewer blocks 160. In some embodiments, the routing program 126 or another program may electronically model the track 110 as the plurality of blocks 160. The routing program 126 then generates a routing plan for routing individual ones of the sample carriers 108 to and through adjacent ones of the blocks 160. The routing program 126 may, in some embodiments, generate a queue of block commands based on the routing plan for every one of the blocks 160 and then transmit those block commands to appropriate segment controllers 128 for execution. In other embodiments, the routing plan is forwarded to appropriate segment controllers 128, which then generate respective queues of block commands for the blocks under their control. The block commands instruct individual ones of the blocks 160 to receive certain sample carriers 108 from specific adjacent blocks and to move out those sample carriers 108 to other specific adjacent blocks. The individual segment controllers 128 may instruct specific transport mechanisms 154 to move a sample carrier 108 from one block to an adjacent block when that adjacent block is vacant in accordance with execution of the generated block commands. One of the advantages of the block modeling is that planning, executing, and monitoring movements of the sample carriers 108 becomes much simpler because only movements of the sample carriers 108 from block to block needs to be considered by individual segment controllers 128 as opposed to computer 120 (executing the routing program 126) directing every movement of every sample carrier 108 on the physical track 110.

The block diagram 200 models the physical space (where sample containers 104 or sample carriers 108 can travel) on the track 110 as the blocks 160. The embodiments herein describe moving the sample carriers 108 (carrying sample containers 104) from one block 160 to an adjacent block 160. Each of the blocks 160 has a movement pattern that indicates the permitted direction(s) (indicated by arrows) in which the sample carriers 108 can move into and out of each of the blocks 160. By default, the movement patterns may be defined by the physical layout of the track 110. For example, a four-way intersection having four ports may have a default movement pattern into and out of each of the four ports. The movement patterns may indicate physical constraints wherein portions of the track 110 corresponding to one or more of the blocks 160 may only allow the sample carriers 108 to move in specific directions. The movement pattern for a particular block may be included in the associated block control program 130 for that block. In some embodiments, the movement patterns may be changeable. For example, software, such as the routing program 126 and/or the block control programs 130 (of the segment controllers 128), may determine the directions of the movement pattern for each of the blocks 160. These directions, for example, may temporarily limit some of the blocks to having only one-way (e.g., left to right) movement there through. Thus, in some embodiments, the movement patterns may not be fixed and may be changed by the routing program 126 and/or the block control programs 130 in response to, e.g., track component failures and/or changes to a routing plan.

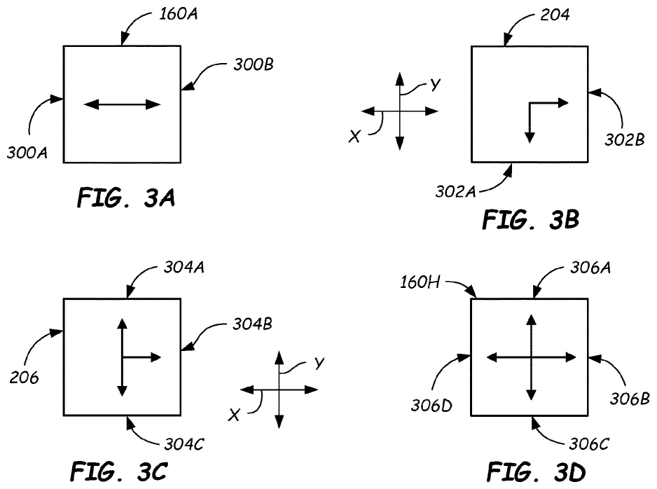

Additional reference is made to FIG. 3A, which illustrates an enlarged view of the first block 160A, which, in some embodiments, may be identical to at least the blocks 160B, 160D, and 160E and other blocks representing straight segments of the track 110. The block 160A has a first port 300A and a second port 300B illustrated with a double-headed arrow between the first port 300A and the second port 300B. The double-headed arrow indicates the permitted movement through the first block 160A wherein the sample carriers 108 (and thus sample containers 104) can be received into and moved out from both the first port 300A and the second port 300B.

Referring again to FIG. 2, a block 204 is a corner block corresponding to the second segment 144 of FIG. 1B. The block 204 is configured to change the direction of sample carriers 108 between the x-direction and the y-direction. Additional reference is made to FIG. 3B, which illustrates an enlarged view of the block 204. The block 204 has a first port 302A and a second port 302B illustrated with a double-headed arrow between the first port 302A and the second port 302B. The double-headed arrow indicates the permitted movement through the block 204 wherein the sample carriers 108 (and thus the sample containers 104) can be received into and moved out from both the first port 302A and the second port 302B, which causes the sample carriers 108 to change direction between the x-direction and the y-direction.

Referring again to FIG. 2, a block 206 is an intersection block corresponding to the third segment 146 of FIG. 1B. The block 206 is configured to receive a sample carrier into a first port and transport the sample carrier out of one of two other ports. Additional reference is made to FIG. 3C, which illustrates an enlarged view of the block 206. The block 206 has a first port 304A, a second port 304B, and a third port 304C illustrated with arrows between the first port 304A, the second port 304B, and the third port 304C. The arrows indicate the permitted movements through the block 206, wherein the sample carriers 108 (and thus the sample containers 104) can be received into one port and moved out of one of the other two ports or received into one of two ports and moved out of a third port.

Other blocks shown in FIG. 2 include a block 208, which is an intersection block corresponding to the fourth segment 148 of FIG. 1B. The block 208 is configured similar to the block 206. A block 210 is a corner block corresponding to the fifth segment 150 of FIG. 1B, and a block 212 is a corner block corresponding to the sixth segment 152 of FIG. 1B. The block 210 and the block 212 are configured similar to the block 204. The block 210 is a mirror of block 204, and the block 212 is a mirror of block 210.

A block 160H shown in FIG. 2 is a 4-way intersection block that corresponds to the intersection segment 190 of FIG. 1A. The block 160H is configured to receive the sample carriers 108 into and move the sample carriers 108 out from first, second, third, or fourth ports. Additional reference is made to FIG. 3D, which illustrates an enlarged view of the block 160H. The block 160H has a first port 306A, a second port 306B, a third port 306C, and a fourth port 306D that allow the sample carriers 108 to enter and exit any of the ports.

Reference is now made to certain ones of the blocks 160 that correspond to the first segment 142 (FIG. 1B) and the parallel seventh segment 153 of the track 110 to illustrate examples of moving sample containers as described below. The blocks 160A-160J (FIG. 2) correspond to portions of the first segment 142 and the seventh segment 153 in the physical track 110. In this example, the portion of the first segment 142 of the physical track 110 is configured to have therein five of the sample carriers 108 and thus has five blocks 160A-160E. The portion of the seventh segment 153 of the physical track 110 is also configured to have therein five of the sample carriers 108 and thus has the five blocks 160F-160J. Each of the blocks 160A-160J in this example is configured to have therein only one sample carrier 108 at a time, and movement of the sample carriers 108 is from one block to an adjacent vacant block. In some embodiments, the blocks 160 may be configured to have therein more than one sample carrier (e.g., in large enough blocks) wherein distance between sample carriers 108 within the block is still sufficient to avoid collisions.

In summary, a queue of block commands is generated for each of the blocks 160, wherein the queue of block commands may indicate from where the sample carriers 108 are to enter the blocks 160 and to where the sample carriers 108 are to exit the blocks 160. The individual segment controllers 128 each execute the block commands associated with the one or few blocks 160 under their respective control. That is, no one controller controls all the sample carrier movements across the entire track 110.

Input to the routing program 126 may include the physical layout of the track 110, the current positions of the sample carriers 108, as well as a corresponding list of destinations for each of the sample carriers 108. The routing program 126, or another program, may model the track 110 as a plurality of blocks based on input parameters, such as, e.g., track layout, track dimensions, sample carrier dimensions, number of permitted sample carriers per block, number/capability/location of segment controllers and track sensors, etc.

Based on the modeled track 110 and the sample carrier 108 inputs above, the routing program 126 generates a routing plan, which includes the paths (and associated blocks) over which each of the sample carriers 108 currently on the track 110 will follow. Thus, the routing program 126 determines which of the blocks 160 each sample carrier will travel through. After the routing plan is generated, the routing plan is transformed (by the routing program 126 or the associated segment controllers 128) into a queue of block commands for each of the blocks 160. A block command may include the time steps, whether a sample carrier is to enter or exit the block, a sample carrier identification, and a direction of movement of the sample carrier. In some embodiments, the position of all the sample carriers 108 at each time step may be indicated. If it is necessary to have a sample carrier wait in a block for a certain amount of time (or until a certain time) the block command may include an appropriate wait command.

At this point in the route planning, each of the blocks 160 has an associated series of block commands that depend on the order in which the sample carriers 108 arrive at the blocks 160 and/or depart from the blocks 160. As described herein, in some embodiments, the time steps for each of the block commands may be ignored because movement of the sample carriers 108 is event-driven, not time-driven. As long as each queue of block commands is performed in order (executed by their respective segment controller 128), the routing plan will execute correctly. Specifically, each of the sample carriers 108 will reach their destinations without colliding and in the correct order. In some embodiments, the arrival times of the sample carriers 108 may differ from the original routing plan, but the order of the sample carrier arrivals may be preserved.

In some embodiments, the route planning can be generated or revised in a continuous fashion. For example, a route plan may be generated or revised after a predetermined number of time steps have been executed. In another embodiment, additional route planning may occur in response to track sensors indicating vacancies in blocks in and around the sampler handler 102C and/or instruments 102A, B. In other embodiments, a route plan may be generated or revised when one or more new sample containers are received into the laboratory system 100. A route plan may also be generated or revised when a change occurs in the laboratory system 100 that requires the sample containers 104 to visit different instruments, such as when an instrument fails or supplies for an instrument are depleted.

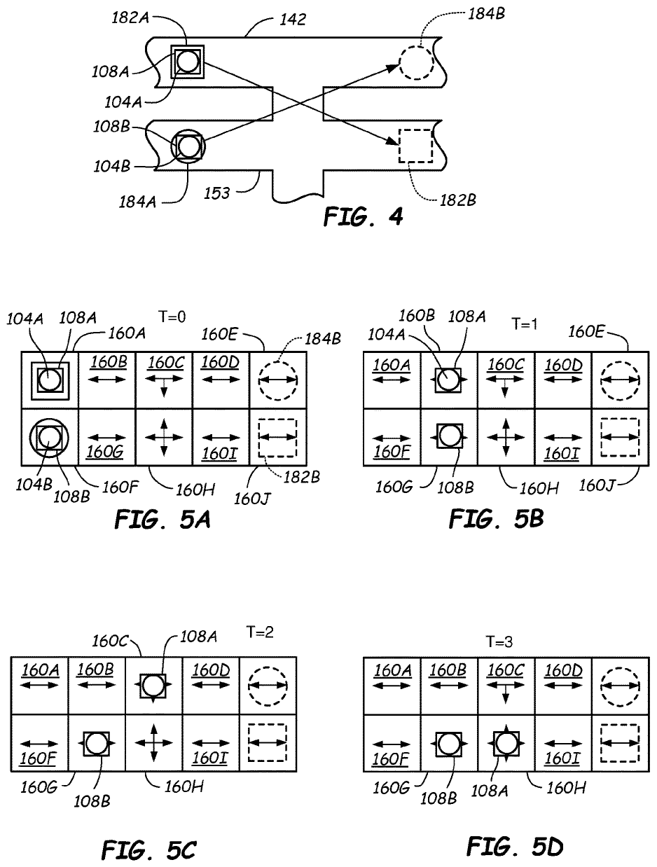

The methods described herein are illustrated in examples described below. Reference is made to FIG. 1A and FIG. 4 wherein the first sample carrier 108A is programmed to move from a location 182A to a destination 182B and the second sample carrier 108B is programmed to move from a location 184A to a destination 184B. FIG. 4 illustrates an enlarged view of portions of the first segment 142 and the seventh segment 153 (FIG. 1B) of the track 110.

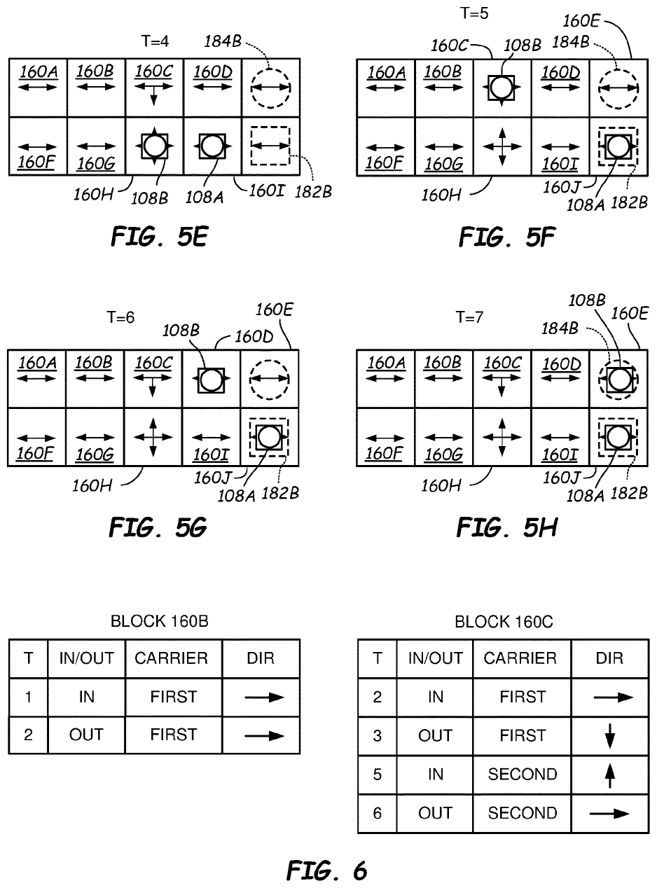

Additional reference is made to FIGS. 5A-5H, which are block diagrams of the portion of the track 110 shown in FIG. 4 at various time steps and show the first sample carrier 108A and the second sample carrier 108B in various positions. The states of the track 110 and the blocks 160 illustrated in FIGS. 5A-5H are planned by the routing program 126. The block diagram of FIG. 5A illustrates the first sample carrier 108A at the location 182A (FIG. 4), which corresponds to the block 160A. The destination of the first sample carrier 108A is the destination 182B (FIGS. 4 and 5A), which corresponds to the block 160J. The second sample carrier 108B is at the location 184A (FIG. 4), which corresponds to the block 160F. The destination of the second sample carrier 108B is the destination 184B, which corresponds to block 160E. The state of the track 110 and the blocks 160 in FIG. 5A is an initial state at time zero or T=0. To plan the routes of the first sample carrier 108A and the second sample carrier 108B, the locations of the sample carriers 108 may be identified and transmitted to the routing program 126.

FIG. 5B shows the state of the track at the next time step, which is T=1. At this stage of the route plan, the routing program 126 or the block control programs 130 of the segment controllers 128 associated with the blocks shown in FIG. 5B have generated block commands to move the first sample carrier 108A to the block 160B and the second sample carrier 108B to the block 160G. For example, a first segment controller 128 may control movement of sample carriers 108 (FIG. 1A) in the block 160A, a second segment controller 128 may control movement of sample carriers 108 in the block 160B, and a third segment controller 128 may control movement of the sample carriers 108 in the block 160C. Thus, both the first segment controller 128 and the second segment controller 128 may generate instructions for the transport mechanisms 154 to move the first sample carrier 108A from block 160A to block 160B based on the block commands determined from the routing plan. Segment controllers 128 (not shown) associated with the block 160F and the block 160G may generate instructions also based on the block commands determined from the routing plan for the transport mechanisms 154 to move the second sample carrier 108B from block 160F to block 160G.

Both the first sample carrier 108A and the second sample carrier 108B will need to occupy the block 160C and the block 160H in order to reach their respective final destinations. Accordingly, either the first sample carrier 108A or the second sample carrier 108B will have to wait while the other sample carrier 108B or 108A passes through block 160C and block 160H. The generated block commands (by the routing program 126 or the block control programs 130 of the segment controllers 128 associated with the blocks 160C and 160H) direct the sample carrier having a higher priority sample to proceed first through the block 160C and the block 160H. In the event that neither sample container has a higher priority sample, the generated block commands may direct the sample carrier that may be blocking other sample carriers having higher priority samples to proceed first. In other embodiments, the block commands may direct the sample carrier carrying the oldest sample to proceed first. Other factors may be used to determine sample carrier order.

In this example, the sample carried by the first sample carrier 108A has priority over the second sample carrier 108B, so the one or more appropriate segment controllers 128 generates instructions to move the first sample carrier 108A to the block 160C at T=2 as shown in FIG. 5C. Because the first sample carrier 108A has priority, the generated block commands direct the second sample carrier 108B to wait in the block 160G. One or more appropriate segment controllers 128 then generates instructions to move the first sample carrier 108A to the block 160H while the second sample carrier 108B continues to wait in the block 160G at T=3 as shown in FIG. 5D.

At the time step T=4 (FIG. 5E), the generated block commands cause the appropriate segment controller 128 to move the first sample carrier 108A from the block 160H to the block 160I as shown in FIG. 5E. The generated block commands also cause the appropriate segment controller 128 to move the second sample carrier 108B from the block 160G to the block 160H as also shown in FIG. 5E. From this time forward, the generated block commands (via one or more appropriate segment controllers 128) cause the sample carriers to move to their appropriate destinations 182B, 184B (FIG. 4). That is, at the time step T=5, the appropriate segment controller 128 causes the first sample carrier 108A to move from the block 160I to the block 160J as shown in FIG. 5F, which is the destination 182B. Also at time step T=5, the appropriate segment controller 128 causes the second sample carrier 108B to move from the block 160H to the block 160C. The second sample carrier 108B then moves via execution of generated block commands by an appropriate segment controller 128 from the block 160C to the block 160D at time step T=6 as shown in FIG. 5G. The second sample carrier 108B next moves via execution of generated block commands by an appropriate segment controller 128 from the block 160D to the block 160E at T=7 as shown in FIG. 5H. In this example, the block 160E is the destination 184B for the second sample carrier 108B.

In some embodiments, after the routing plan is generated, which includes a list of all blocks through which sample carriers traverse, the routing plan may be transformed by the processor 122 (executing routing program 126) or one or more processors of one or more respective segment controllers 128 (executing respective block control programs 130) into a queue of block commands for each of the blocks 160. Each queue of block commands may include the carrier identifications, directions of movement of the sample carriers, and blocks from which the sample carriers are exiting and/or blocks to which the sample carriers are entering.

Additional reference is made to FIG. 6, which illustrates an example of two queues of block commands, one for the block 160B and the other for block 160C, wherein each are related to the example above illustrated in FIGS. 5A-5H. A separate queue of blocks commands may be generated for each of the blocks 160. The two queues of block commands shown in FIG. 6 may be generated by and/or executed by respective segment controllers 128 (FIG. 1A) for the blocks 160B and 160C based on the routing plan generated by routing program 126. In other embodiments, the queues of block commands in FIG. 6 may also be generated by the routing program 126 and forwarded to the appropriate segment controllers 128 to be executed by their respective processors and block control programs 130.

In the queues of FIG. 6, the block commands show times (T) in which sample carriers enter, exit, or wait in the block 160B and the block 160C. Prior to time step T=2, no action is performed with respect to the block 160C relative to this example. At time step T=1, the block 160B receives the first sample carrier 108A from the left (block 160A) (see FIG. 5B). At time step T=2, the block 160C receives the first sample carrier 108A from the left (block 160B) (see FIG. 5C). At time step T=3, the first sample carrier 108A exits from the block 160C and moves into the block 160H, which is in the downward direction as illustrated in FIG. 5D. No action is taken at step T=3 with respect to the block 160B, thus it does not appear in the queue of block commands for the block 160B. No action is also taken at step T=4 with respect to the blocks 160B and 160C (see FIG. 5E), thus it does not appear in the queue of block commands for the blocks 160B and 160C. At time step T=5, the second sample carrier 108B is received from the block 160H into the block 160C, which is in the upward direction as illustrated in FIG. 5F. At time step T=6, the second sample carrier 108B is moved to the right into the block 160D. If it is necessary to have carriers wait at a block for a certain amount of time (or until a certain time step), a wait command can be added to the IN/OUT field.

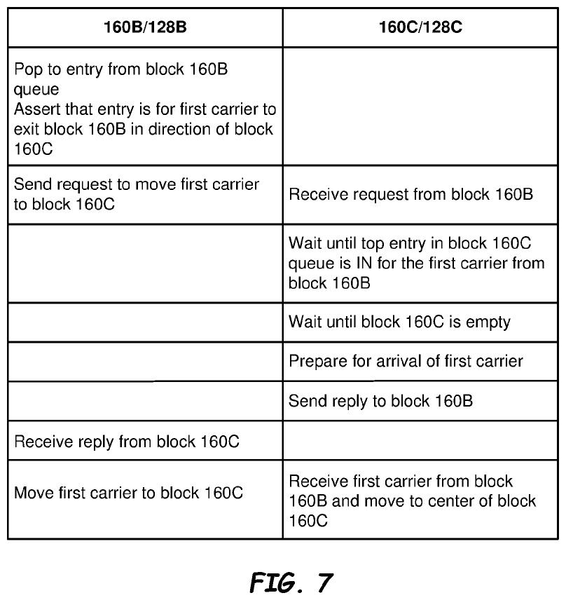

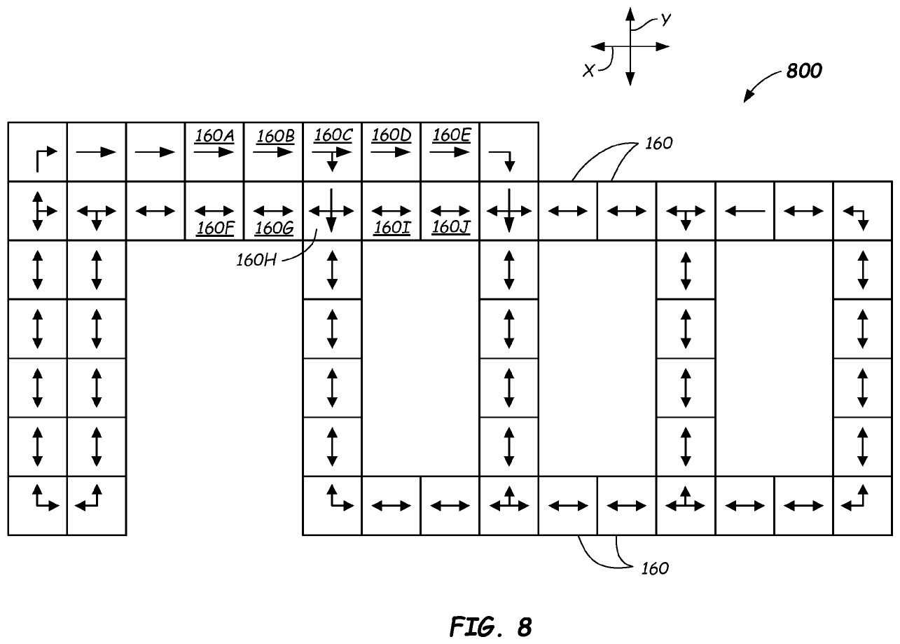

In some embodiments, any actual timings associated with the time steps may be ignored, while the queue of block commands is executed in order. Additional reference is made to FIG. 7, which illustrates detailed sub-commands for executing the block command related to time step T=2 in FIG. 6, wherein the first sample carrier 108A is moved from the block 160B to the block 160C. The sub-commands are executed from a top or first entry in the queue of block commands and may be executed by one or two appropriate segment controllers 128 (FIG. 1A) that control movement through block 160B and block 160C. As described herein, the commands and sub-commands may be executed in order irrespective of time, which results in event-driven or event-dependent commands and sub-commands rather than time-driven or time-dependent commands and sub-commands.

The sub-commands described in FIG. 7 relate to the block command of moving the first sample carrier 108A out of the block 160B and into the block 160C. Based on FIG. 6, the movement is in the right direction, which is from the block 160B to the block 160C. The sub-commands described in FIG. 7 commence with initializing the block 160B or configuring the appropriate segment controller 128 to control the block 160B. The first sub-command may be referred to as, “pop to entry from block 160B queue,” as shown in FIG. 7. The sub-commands further include recognizing that the instructions are to move the first sample carrier 108A from the block 160B to the block 160C, which may be referred to in FIG. 7 as, “Assert that entry is for first carrier to exit the block 160B in direction of block 160C.” The next sub-command sends a message from the segment controller 128 controlling movement through block 160B to the segment controller 128 controlling movement through block 160C. The message requests that the first sample carrier 108A be moved from the block 160B to the block 160C.

The segment controller 128 associated with the block 160C waits until a request to receive the first sample carrier 108A (e.g., in the form of an IN command) is received. The request may include information that the first sample carrier 108A is coming from block 160B and is received from the segment controller 128 associated with the block 160B. The next sub-command is referred to in FIG. 7 as, “Wait until top entry in block 160C queue is IN for the first carrier.” Because the commands and thus the sub-commands are event-driven, the segment controller 128 for block 160C waits until the sub-command related to receiving the first sample carrier 108A is next in the processing order.

The next sub-command in the example of FIG. 7 waits for block 160C to be vacant (i.e., no sample carriers therein) and is referred to as, “Wait until block 160C is empty.” The track sensors 156 (FIG. 1B) may send vacancy status data to the segment controller 128 associated with the block 160C, which may determine whether the block 160C is vacant. The segment controller 128 associated with the block 160B may be configured to request vacancy status of the block 160C. The following sub-command prepares block 160C to receive the first sample carrier 108A and is referred to as, “Prepare for arrival of first carrier.” This preparation may include initializing the transport mechanisms 154 associated with the block 160C to move the first sample carrier 108A into the block 160C.

Next, the reply to the request sent from the segment controller 128 associated with the block 160B is returned to the segment controller 128 associated with block 160B. Specifically, the next executed sub-command causes the segment controller 128 associated with the block 160C to send an instruction to the segment controller 128 associated with block 160B indicating that the block 160C is vacant. The segment controller 128 associated with block 160B may then generate instructions that cause the transport mechanisms 154 to move the first sample carrier 108A from the block 160B to the block 160C as described above with reference to FIGS. 1D-1G. The transport mechanism instructions associated with the move sub-command may terminate in response to the block 160C receiving and moving the first sample carrier 108A to the middle of the block 160C. These sub-commands are described in FIG. 7 as, “Receive first carrier from block 160B and move to center of block 160C.” The segment controllers 128 may move the sample carriers 108 to the middle of the blocks 160 so that the sample carriers 108 do not interfere or collide with each other and are able to exit the blocks 160 with minimal movement. For example, the block 206 (FIG. 3C) is an intersection block, so the sample carriers 108 may exit via one of two ports. By having the sample carriers 108 in the middle of the block 206, the sample carriers 108 are ready to exit directly to adjacent blocks without having to be aligned with the adjacent blocks prior to being moved.

Returning to FIG. 2, the block diagram 200 shows the blocks 160 having movement patterns that limit the sample carriers 108 to moving on the track 110 (FIG. 1) only as indicated by the double-headed arrows. In other embodiments, the movement patterns may be more restrictive. For example, the movement patterns may only allow one-way movement through certain blocks or limit exit and/or entry out of and into certain intersection blocks. In some embodiments, the segment controllers 128 and/or the routing program 126 may set the movement patterns.

Additional reference is made to FIG. 8, which illustrates a block diagram 800 of blocks 160 that have movement patterns different than the blocks 160 of FIG. 2. In some embodiments, a user and/or the routing program 126 (FIG. 1A) may determine the movement patterns. In the embodiment of FIG. 8, the blocks 160A, 160B, 160D, and 160E have one-way movement patterns permitting only movements from left to right. The block 160H has a movement pattern that does not allow upward movement (as shown on the page) to block 160C. The block 160C has a movement pattern that does not allow movement to the left of block 160C. The segment controllers 128 (FIG. 1A) may generate block commands that move the sample carriers 108 per the movement patterns.

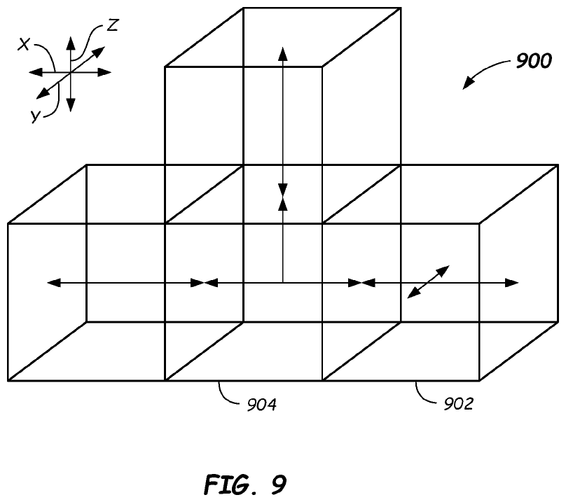

Referring to FIGS. 2 and 8, the blocks 160 have been illustrated as being square or rectangular. Other block shapes may be used. For example, pentagonal-shaped blocks may be used to represent intersection segments having five ports. The movements of sample carriers 108 and sample containers 104 have been described as being in a two-dimensional plane. Thus, the blocks 160 have also been described as being two-dimensional. In other embodiments, movement of the sample containers 104 and/or the sample carriers 108 may be in three dimensions, such X, Y, and Z (e.g., as normal to the track 110) as described below in connection with FIG. 9. In such embodiments, one or more of the blocks 160 may be three-dimensional such as cube-shaped.

Reference is made to FIG. 9, which illustrates a three-dimensional block diagram 900 of a portion of a track (not separately shown) that may move sample carriers 108 (FIG. 1A) carrying sample containers 104 in three dimensions. That is, in some embodiments of automated diagnostic laboratory system 100, the transport system may have more than one level wherein one or more elevator-type mechanisms may move a sample carrier 108 from a block on one level to a block on another level. In the embodiment of FIG. 9, the sample carriers 108 are configured to move in an x-direction, a y-direction, and a z-direction to adjacent vacant blocks. A block 902, e.g., has a movement pattern that limits movements to only the x-direction and the y-direction. A block 904, e.g., has a movement pattern that limits movements to only the y-direction and the z-direction. Other blocks may have other movement patterns. The routing program 126 routes the sample carriers 108 to and from adjacent blocks or cubes as described above.

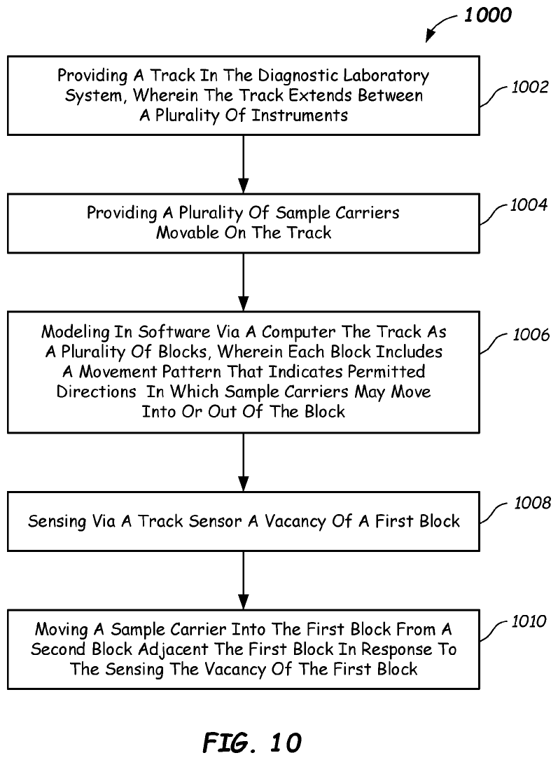

Reference is now made to FIG. 10, which illustrates a flowchart of a method 1000 of operating a diagnostic laboratory system (e.g., laboratory system 100) for analyzing a biological sample (e.g., sample 162A). The method 1000 includes, in block 1002, providing a track (e.g., track 110) in the diagnostic laboratory system, wherein the track extends between a plurality of instruments (e.g., instruments 102).

The method 1000 includes, in block 1004, providing a plurality of sample carriers (e.g., sample carriers 108) movable on the track. The sample carriers 108 may move sample containers 104 on the track 110 from the sample handler 102C to one or more of the instruments 102 and then back to the sample handler 102C.

The method 1000 includes, in block 1006, modeling in software via a computer the track (e.g., track 110) as a plurality of blocks (e.g., blocks 160), wherein each block includes a movement pattern that indicates the permitted direction(s) in which the plurality of sample carriers may move into or out of the block. In some embodiments, the blocks 160 may be large enough to have therein a single sample container, but smaller than two of the sample containers 108 set side-by-side. The movement patterns define allowable movement through each of the blocks 160.

The method 1000 includes, in block 1008, sensing via a track sensor a vacancy of a first block (e.g., block 160B). In some embodiments, the sample carriers 108 may only be able to move into vacant blocks, so the vacancy status of the blocks 160 should be determined before the sample carriers 108 are moved on the track 110.

And the method 1000 includes, in block 1010, moving a sample carrier into the first block from a second block adjacent the first block in response to the sensing the vacancy of the first block.

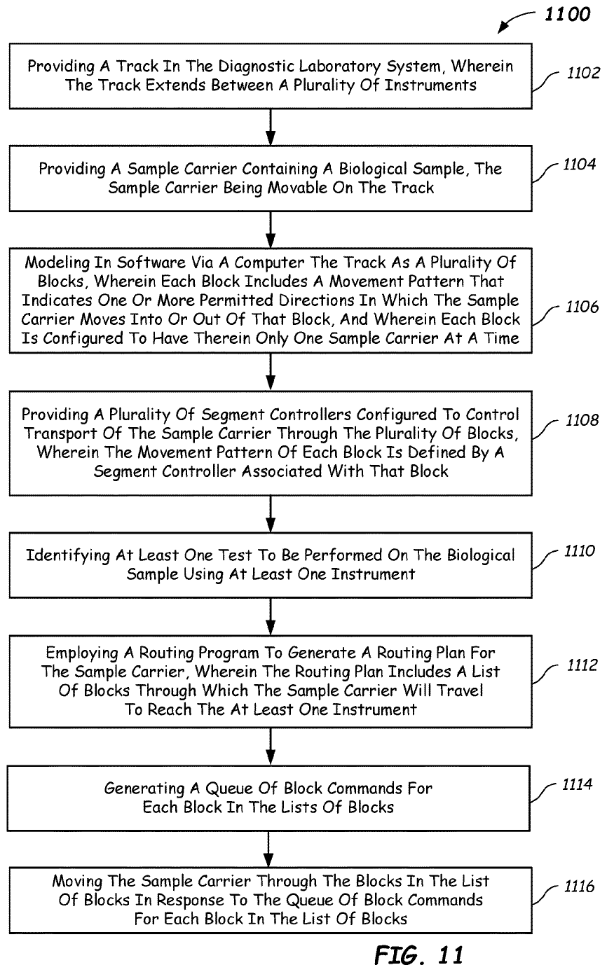

Reference is now made to FIG. 11, which illustrates a flowchart of a method 1100 of moving a sample carrier (e.g., first sample container 108A) in a diagnostic laboratory system (e.g., laboratory system 100) for analyzing biological samples (e.g., sample 162A). The method 1100 includes, in block 1102, providing a track (e.g., track 110) in the diagnostic laboratory system 100, wherein the track 110 extends between a plurality of instruments (e.g., instruments 102).

The method 1100 includes, in block 1104, providing a sample carrier (e.g., sample carrier 108A) carrying a biological sample (e.g., biological sample 162A) contained in a sample container (e.g., sample container 104), the sample carrier being movable on the track (e.g., track 110).

The method 1100 includes, in block 1106, modeling in software via a computer the track (e.g., track 110) as a plurality of blocks (e.g., blocks 160), wherein each block includes a movement pattern that indicates the permitted direction(s) in which the sample carrier (e.g., sample carrier 108A) may move into and out of that block, and wherein each block is configured to have therein only one sample carrier at a time. In some embodiments, the blocks 160 may be slightly larger than the largest sample carrier and smaller than the size of two sample carriers set side by side, for example.

The method 1100 includes, in block 1108, providing a plurality of segment controllers (segment controllers 128) configured to control transport of the sample carrier (e.g., sample carrier 108A) through the plurality of blocks (e.g., blocks 160), wherein the movement pattern of each block is defined by a segment controller associated with that block. In some embodiments, a single segment controller may be associated with a plurality of the blocks (e.g., blocks 160).

The method 1100 includes, in block 1110, identifying at least one test to be performed on the biological sample using at least one instrument (e.g., instruments 102).

The method 1100 includes, in block 1112, employing a routing program (e.g., routing program 126) to generate a routing plan for the sample carrier (e.g., sample carrier 108A) carrying the biological sample (e.g., biological sample 162A) via a sample container (e.g., sample container 104), wherein the routing program includes a list of blocks through which the sample carrier will travel to reach the at least one instrument.

The method 1100 includes, in block 1114, generating a queue of block commands for each block in the lists of blocks (through which the sample carrier will travel). Block commands may be generated by a routing program executing in a computer or by a block control program executing in a segment controller. The block commands may include receiving a sample carrier from an adjacent block, moving a sample carrier to a specific adjacent block, and waiting, which includes holding a sample carrier in a block.

And the method 1100 includes, in block 1116, moving the sample carrier through the blocks (e.g., blocks 160) in the list of blocks based on the queue of block commands for each block in the list of blocks. For example, the sample carrier 108A may move between adjacent ones of the blocks 160, which may be in a direction toward the instrument that is to perform the test.

While the disclosure is susceptible to various modifications and alternative forms, specific method and apparatus embodiments have been shown by way of example in the drawings and are described in detail herein. It should be understood, however, that the particular methods and apparatus disclosed herein are not intended to limit the disclosure.

What is claimed is:

1. A method of operating a diagnostic laboratory system for analyzing a biological sample, comprising:
providing a track in the diagnostic laboratory system, wherein the track extends between a plurality of instruments;
providing a plurality of sample carriers movable on the track;
modeling in software via a computer the track as a plurality of blocks, wherein each block includes a movement pattern that indicates permitted directions in which sample carriers move into or out of the block;
sensing via a track sensor a vacancy of a first block; and
moving a sample carrier into the first block from a second block adjacent the first block in response to the sensing the vacancy of the first block.

2. The method of claim 1, wherein each block is configured to have therein only one sample carrier at a time.

3. The method of claim 1, further comprising providing one or more segment controllers programmed to control transport of the plurality of sample carriers through the plurality of blocks.

4. The method of claim 1, wherein sensing the vacancy of the first block comprises sensing via the track sensor the vacancy of the first block and communicating the sensing from the track sensor to a first segment controller associated with the first block, the first segment controller operative to control movement of a sample carrier in the first block.

5. The method of claim 4, wherein:
the first segment controller is operative to also control movement of a sample carrier in the second block; and
the moving the sample carrier from the second block to the first block comprises moving the sample carrier from the second block to the first block in response to communication from the first segment controller to the sample carrier in the second block or to transport components of the track operative to move the sample carrier from the second block to the first block.

6. The method of claim 4, wherein the moving the sample carrier from the second block to the first block comprises:
sending a request from a second segment controller associated with the second block to the first segment controller for the first block to receive the sample carrier from the second block;
sending a reply from the first segment controller to the second segment controller in response to the communicating the sensing of the vacancy from the track sensor to the first segment controller; and
the moving the sample carrier from the second block to the first block comprises moving the sample carrier from the second block to the first block in response to the second segment controller receiving the reply from the first segment controller.

7. The method of claim 1, further comprising identifying at least one test to be performed on a biological sample using at least one instrument, wherein the moving comprises moving the sample carrier toward the at least one instrument.

8. The method of claim 1, further comprising:
obtaining a current position of each of the plurality of sample carriers;
obtaining destinations for each of the plurality of sample carriers;
employing a routing program to generate a routing plan for each sample carrier that includes a list of blocks through which the sample carriers will travel to reach their destinations; and
for each block, generating a queue of block commands based on the lists of blocks through which each of the plurality of sample carriers will travel.

9. The method of claim 8, wherein the queue of block commands for each of the plurality of blocks includes sub-commands of receiving a sample carrier at the block, moving the sample carrier from the block, and waiting.

10. The method of claim 8, wherein moving a sample carrier from the second block to the first block in response to sensing vacancy in the first block comprises executing a queue of block commands for the first block and a queue of block commands for the second block.

11. A diagnostic laboratory system for analyzing a biological sample, comprising:
at least one instrument for preparing or testing the biological sample;
a track configured to transport a sample container to and from the at least one instrument, wherein the sample container is configured to contain therein the biological sample to be analyzed;
a computer configured to:
model in software the track as a plurality of blocks, wherein each block includes a movement pattern that indicates one or more permitted directions in which the sample container moves into or out of the block;
identify at least one test to be performed on the biological sample by the at least one instrument;
determine a path along the track to the at least one instrument, wherein the path includes at least a first block and a second block adjacent the first block;
a first segment controller associated with the first block; and
a second segment controller associated with the second block and in communication with the first segment controller;
wherein the first segment controller is operative to communicate that the first block is vacant; and
wherein the second segment controller is operative to facilitate movement of the sample container from the second block to the first block in response to receiving communication from the first segment controller that the first block is vacant.

12. The diagnostic laboratory system of claim 11, wherein each block is configured to have therein only one sample carrier at a time.

13. The diagnostic laboratory system of claim 11, further comprising a plurality of segment controllers configured to control transport of a plurality of sample carriers through the plurality of blocks.

14. The diagnostic laboratory system of claim 13, wherein the movement pattern of a block of the plurality of blocks is defined by a segment controller associated with the block of the plurality of blocks.

15. The diagnostic laboratory system of claim 11, wherein the second segment controller is configured to request a vacancy status of the first block from the first segment controller.

16. The diagnostic laboratory system of claim 15, wherein the first segment controller is operative to send a reply to the second segment controller in response to sensing that the first block is vacant.

17. The diagnostic laboratory system of claim 11, wherein the diagnostic laboratory system is configured to transport a plurality of sample carriers and wherein the computer is configured to:
obtain a current position of each of the plurality of sample carriers;
obtain a destination for each of the plurality of sample carriers;
employ a routing program to generate a routing plan for each of the plurality of sample carriers, wherein each routing plan includes a list of blocks through which each of the plurality of sample carriers will travel to reach their destinations; and
for each block, generate a queue of block commands based on the lists of blocks through which each of the plurality of sample carriers will travel.

18. The diagnostic laboratory system of claim 17, wherein the queue of block commands for each of the plurality of blocks includes sub-commands of receiving a sample carrier at the block, moving a sample carrier from the block, and waiting.

19. The diagnostic laboratory system of claim 17, wherein the first segment controller is operative to execute a queue of block commands for the first block, and the second segment controller is operative to execute a queue of block commands for the second block.

20. A method of moving a sample carrier in a diagnostic laboratory system for analyzing biological samples, the method comprising:
providing a track in the diagnostic laboratory system, wherein the track extends between a plurality of instruments;
providing a sample carrier containing a biological sample, the sample carrier movable on the track;
modeling in software via a computer the track as a plurality of blocks, wherein each block includes a movement pattern that indicates one or more permitted directions in which the sample carrier moves into or out of that block, and wherein each block is configured to have therein only one sample carrier at a time;
providing a plurality of segment controllers configured to control transport of the sample carrier through the plurality of blocks, wherein the movement pattern of each block is defined by a segment controller associated with that block;
identifying at least one test to be performed on the biological sample using at least one instrument;
employing a routing program to generate a routing plan for the sample carrier, wherein the routing plan includes a list of blocks through which the sample carrier will travel to reach the at least one instrument;
generating a queue of block commands for each block in the list of blocks; and
moving the sample carrier through the blocks in the list of blocks in response to the queue of block commands for each block in the list of blocks.
